(19) United States
(12) Patent Application Publication
(10) Pub. No.: US 2022/0373644 A1
(43) Pub. Date: Nov. 24, 2022

(54) DEFINING A PROTECTED REGION FOR A RADAR DETECTOR

(71) Applicant: Carrier Corporation, Palm Beach Gardens, FL (US)

(72) Inventors: Mateusz Mazur, Sopot (PL); Michael Ramoutar, Westford, MA (US); Leszek Wolski, Reda (PL); Ziyou Xiong, Wethersfield, CT (US)

(21) Appl. No.: 17/742,567

(22) Filed: May 12, 2022

Related U.S. Application Data
(60) Provisional application No. 63/192,272, filed on May 24, 2021.

(51) Int. Cl. G01S 7/40; G01S 13/88; G01S 13/04

(52) U.S. Cl. CPC G01S 7/40; G01S 13/886; G01S 13/04

(57) ABSTRACT

A radar detection system can be calibrated by a method which includes selecting location indicators with corresponding locations. A transmitter of a sensor emits a radar signal to the location of each of the location indicators. The radar signal is reflected off of a target at the location of each of the location indicators. The radar signal which has been reflected off of the target is received with a receiver of the sensor. The location of the target at each of the location indicators is communicated between the sensor and a controller. Locations which define a protected region are selected with the controller. The controller designates the protected region, thereby calibrating the radar detection system such that the radar detection system is capable of detecting an object in the protected region. The calibrated radar detection system can detect targets in an operational mode.

### BACKGROUND

The present invention relates generally to radar detection and in particular addresses a radar detection system for a security system which can be calibrated in various ways.

Conventional radar detection systems for area security rely on virtual fences or other borders to define a designated protected region. However, this approach may lack accuracy in the case of irregularly shaped regions, structures within the protected region such as walls, or other obstacles within the protected region. Additionally, this approach may not be easily tailored by a user to a particular protected region.

### SUMMARY

According to one aspect of the invention, a method of calibrating a radar detection system includes selecting location indicators. A radar signal is emitted with a transmitter of a sensor to a location of each of the plurality of the location indicators. The radar signal is reflected off of a target at the location of each of the plurality of location indicators. The radar signal which has been reflected off of the target at the location of each of the plurality of location indicators is received with a receiver of the sensor. The location of the target at each of the plurality of location indicators is communicated between the sensor and a controller. At least one plurality of locations is selected with the controller. The at least one plurality of locations selected with the controller defines a protected region. The protected region is designated with the controller. This method calibrates the radar detection system such that the radar detection system is capable of detecting an object in the protected region.

According to another aspect of the invention, a method of detecting an object in a protected region with a calibrated radar detection system includes emitting, with a transmitter of a sensor, a radar signal to a location of each of a plurality of location indicators. A receiver of the sensor detects if the radar signal has been reflected off of a target at the location of at least one of each of the plurality of location indicators. The sensor communicates to a controller if the radar signal has been reflected off of a target at the location of the at least one of each of the plurality of location indicators. The controller determines that an object is present within the protected region based upon detection of the radar signal being reflected off of the target. The protected region is defined by a plurality of protected subregions, and each of the plurality of protected subregions is defined by a location of each of the plurality of location indicators.

According to yet another aspect of the invention, a radar detector for a security system includes a sensor and a controller. The sensor includes a transmitter, a receiver, and a converter. The transmitter is configured to emit a radar signal to a plurality of location indicators. The receiver is configured to receive a reflection of the radar signal from the transmitter that is reflected off of a target. The controller is configured to communicate with the sensor to record a location of each of the plurality of location indicators. The controller is further configured to select at least one plurality of locations, designate a protected region which is defined by the at least one plurality of locations and thereby calibrate the radar detector, and determine if an object is present in the protected region.

### BRIEF DESCRIPTION OF THE DRAWINGS

The subject matter, which is regarded as the disclosure, is particularly pointed out and distinctly claimed in the claims at the conclusion of the specification. The following descriptions of the drawings should not be considered limiting in any way.

FIG. 1 is a schematic depiction of a radar detection system.

FIG. 2 is a plan view of a radar detection system which is calibrated to use a vector of points and a corresponding vector of radii to define a protected region.

FIG. 3 is a plan view of a radar detection system which is calibrated to use a vector of angles and a corresponding vector of radius ranges to define a protected region.

FIG. 4 is a plan view of a radar detection system which is calibrated to use a vector of x-coordinates and y-coordinates to define a protected region.

FIG. 5 illustrates a method of calibrating a radar detection system.

### DETAILED DESCRIPTION

A protected region is made up of protected subregions. Each protected subregion is defined by location indicators, such as points each surrounded by a plurality of radii or angles each having a selected radius range. A radar detection system can be calibrated by gestures performed at the location of the location indicators, or by selecting the location indicators with a controller. The radar detection system is used to monitor the defined protected subregions and detect objects inside the protected region.

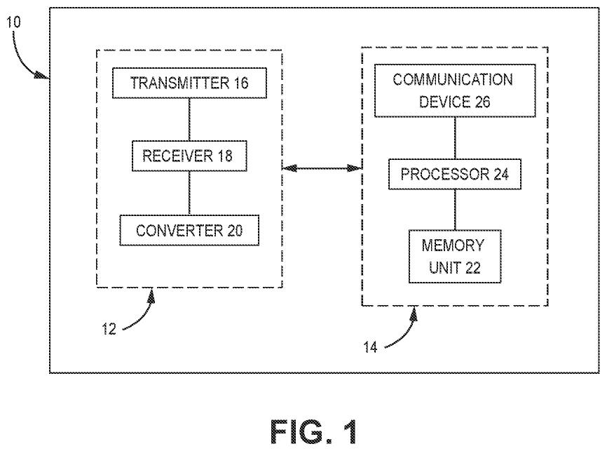

FIG. 1 is a schematic depiction of exemplary radar detection system 10. As shown, radar detection system 10 may include sensor 12 and controller 14. Sensor 12 may include transmitter 16, receiver 18, and converter 20. In some embodiments, sensor 12 can include multiple transmitters 16 and/or receivers 18. Controller 14 may include memory unit 22, processor 24, and communication device 26.

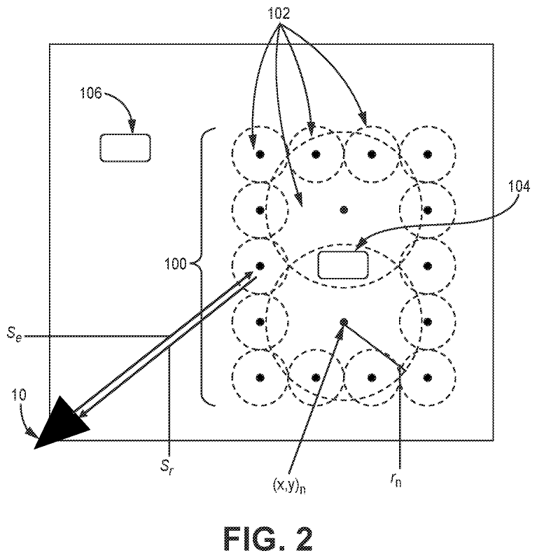

Transmitter 16 is configured to emit a radar signal, such as emitted radar signal Sₑ (shown in FIGS. 2-4), which can be reflected off of a target to create a reflected radar signal Sᵣ (shown in FIGS. 2-4). Receiver 18 is configured to receive a reflected radar signal, such as reflected radar signal Sᵣ, when the reflected radar signal returns to the sensor 12. In this manner, receiver 18 can detect a reflected radar signal Sᵣ from a target. Transmitter 16 and receiver 18 can be connected to one or more antennae (not shown), and can in some examples be integrated into one chip. The emitted radar signal Sₑ can be pulsed, and transmitter 16 can be configured to emit a radar signal Sₑ at suitable frequencies in microwave (1 GHz to 30 GHz) or millimeter wave (greater than 30 GHz) bands. For example, the transmitter 16 can be configured to emit emitted radar signal Sₑ at 2.4 GHz, 5-6 GHz, 10 GHz, 24 GHz, or 64 GHz. Transmitter 16 can additionally and/or optionally be configured to use a wide spectrum of frequencies, such 2-10 GHz. Converter 20 is an analog/digital converter, and is configured to convert the received reflected radar signal Sᵣ, including positional data about the reflected radar signal Sᵣ, into a digital signal which can be communicated to controller 14. Sensor 12 can additionally include other hardware, software, or firmware components.

As described above, controller 14 may include memory unit 22, processor 24, and communication device 26. In some embodiments, controller 14 can include multiple processors 24 and/or communication devices 26. Controller 14 can additionally include more components, such as an input device, output device, alarm, and/or power source. An input device can include a mouse, a keyboard, a microphone, a camera device, a presence-sensitive and/or touch-sensitive display, or other type of device configured to receive input from a user. An output device can include a display device, a sound card, a video graphics card, a speaker, a cathode ray tube (CRT) monitor, a liquid crystal display (LCD), a light emitting diode (LED) display, an organic light emitting diode (OLED) display, or other type of device for outputting information in a form understandable to users or machines. In examples where controller 14 is configured to transfer and store data via the cloud, the input device and/or output device can be a host computing system off-site and can use applications to, for example, define protected regions or receive information about detected objects.

Processor 24 may be configured to implement functionality and/or process instructions for execution within controller 14. For instance, processor 24 can be capable of processing instructions stored in memory unit 22. Examples of processor 24 can include any one or more of a microprocessor, a controller, a digital signal processor (DSP), an application specific integrated circuit (ASIC), a field-programmable gate array (FPGA), or other equivalent discrete or integrated logic circuitry.

Memory unit 22 can be configured to store information within controller 14 during operation. Memory unit 22, in some examples, is described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory unit 22 is a temporary memory, meaning that a primary purpose of memory unit 22 is not long-term storage. Memory unit 22, in some examples, is described as volatile memory, meaning that memory unit 22 does not maintain stored contents when power to controller 14 is turned off. Examples of volatile memories can include random access memories (RAM), dynamic random access memories (DRAM), static random access memories (SRAM), and other forms of volatile memories. In some examples, memory unit 22 is used to store program instructions for execution by processor 24.

Memory unit 22 can be configured to store larger amounts of information than volatile memory. Memory unit 22 can further be configured for long-term storage of information. In some examples, memory unit 22 includes non-volatile storage elements. Examples of such non-volatile storage elements can include magnetic hard discs, optical discs, flash memories, or forms of electrically programmable memories (EPROM) or electrically erasable and programmable (EEPROM) memories.

Controller 14 may also include communication device 26. Controller 14 can utilize communication device 26 to communicate with external devices via one or more networks, such as one or more wireless or wired networks or both. Communication device 26 can be a network interface card, such as an Ethernet card, an optical transceiver, a radio frequency transceiver, or any other type of device that can send and receive information. For example, communication device 26 can be a radio frequency transmitter dedicated to Bluetooth or WiFi bands or commercial networks such as GSM, UMTS, 3G, 4G, 5G, and others. Alternately, communication device 26 can be a Universal Serial Bus (USB).

Radar detection system 10 can be, for example, configured to detect targets over any area consistent with the range of the transmitter 16 and sensitivity of the receiver 18. For example, the radar detection system 10 can detect targets at a distance of up to 16 meters from the radar detection system 10, and in some embodiments can be configured to detect targets at a distance of up to 20 meters from the radar detection system 10. It will be appreciated that distances greater than 20 meters may be possible in certain instances. In some embodiments, radar detection system 10 can be configured to detect targets over an angular range of 90 degrees. For a radar detection system 10 with a 90 degree field of view, the radar detection system 10 can detect targets over an area equal to one-quarter the area of a circle with a radius equal to the maximum distance at which the radar detection system 10 can detect targets. It will be appreciated that angular ranges greater than or less than 90 degrees may be possible in certain instances. In an embodiment where the radar detection system 10 is configured to detect targets at a distance of up to 16 meters and over an angular range of 90 degrees, the radar detection system 10 can detect targets over an area of approximately 200 square meters. In an embodiment where the radar detection system 10 is configured to detect targets at a distance of up to 20 meters and over an angular range of 90 degrees, the radar detection system 10 can detect targets over an area of approximately 490 square meters.

Radar detection system 10 may be configured to allow a user to select a set of location indicators in order to designate a set of protected subregions. This set of protected subregions defines a protected region. The protected subregions can be discrete areas, and each protected subregion can overlap with other protected subregions as needed to most accurately define the protected region. As described in detail below, the set of location indicators can be, for example, a vector of points with corresponding radius ranges, a vector of angles with corresponding angle ranges, or a vector of points with corresponding x- and y-coordinates.

Processor 24 can be configured to control transmitter 16 and receiver 18. Processor 24 can process positional data of each emitted and reflected radar signal. Memory unit 22 can store positional data of the radar signals and thereby store positional data of the location indicators. Communication device 26 can communicate and network with sensor 12 to communicate positional data of the emitted radar signal Sₑ and reflected radar signal Sᵣ. Sensor 12 may be configured to communicate with controller 14 via communication device 26. In some embodiments, some or all parts of controller 14 can be included within sensor 12.

FIG. 2 is a plan view of exemplary radar detection system 10 which is calibrated to use point vector [(x,y)₁ . . . (x,y)_{N}] and corresponding vector of radii [r₁ . . . r_{N}] to define protected region 100. It should be understood that (x,y)ₙ denotes any of the points in point vector [(x,y)₁ . . . (x,y)_{N}], and rₙ denotes any of the radii in vector of radii [r₁ . . . r_{N}]. Each point (x,y)ₙ can have a corresponding location range, such as radii rₙ, such that point vector [(x,y)₁ . . . (x,y)_{N}] has a corresponding vector of radii [r₁ . . . r_{N}]. Radii rₙ about each point (x,y)ₙ can form circular areas about points (x,y)ₙ with a radius of rₙ. Each set of radii rₙ defines a protected subregion 102.

Radar detection system 10 may be configured to allow a user to select location indicators which make up a vector of points, such as point vector [(x,y)₁ . . . (x,y)_{N}]. Protected region 100 may be defined by the set of protected subregions 102, such that protected region 100 is made up of a set of circular areas. The radii rₙ of each point (x,y)ₙ can be varied as desired to achieve coverage of protected region 100.

During operation, radar detection system 10 can detect the presence of an object within any of protected subregions 102, such as object 104. If sensor 12 detects the presence of object 104 within radii rₙ of any of points (x,y)ₙ, controller 14 can, for example, trigger an alarm. Controller 14 can be further configured to not trigger an alarm if an object is detected outside of any protected subregions 102, such as object 106.

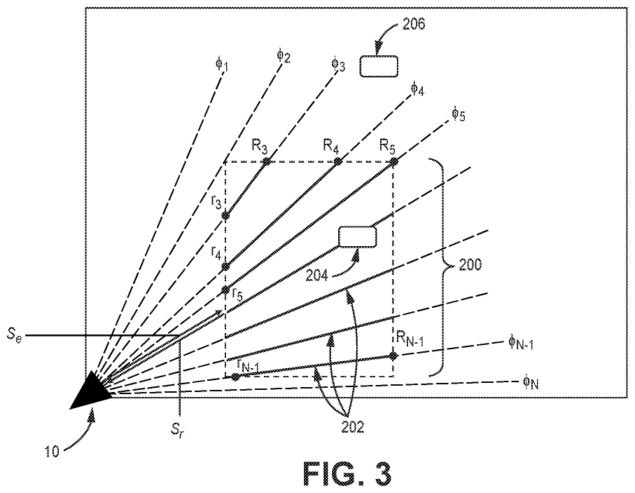

FIG. 3 is a plan view of exemplary radar detection system 10 which is calibrated to use angle vector [ϕ₁ . . . ϕ_{N}] and corresponding vector of radius ranges [r₁ . . . r_{N}] and [R₁ . . . R_{N}] to define protected region 200. As discussed above, ϕₙ denotes any of the angles in angle vector [ϕ₁ . . . ϕ_{N}], rₙ denotes any of the radius ranges in [r₁ . . . r_{N}], and Rₙ denotes any of the radius ranges in [R₁ . . . R_{N}]. Each angle ϕₙ can have a corresponding location range, such as the radius range between rₙ and R_{N}, such that angle vector [ϕ₁ . . . ϕ_{N}] has a corresponding vector of radius ranges [r₁ . . . r_{N}] and [R₁ . . . R_{N}]. Radius range rₙ defines a minimum radius and radius range Rₙ defines a maximum radius along each angle ϕₙ. Radius ranges rₙ and Rₙ along each angle ϕₙ can form a linear segment with a selected length equal to Rₙ-rₙ. Each linear segment extends along angle ϕₙ from radius rₙ to radius Rₙ. Each linear segment defined by radius ranges rₙ and Rₙ defines a protected subregion 202. The length of a protected subregion 202 can be zero if, for example, Rₙ=rₙ, indicating a corner of the protected region 200. For a given angle ϕₙ, points that are outside the corresponding linear segment defined by radius ranges rₙ and Rₙ are outside the protected region 200. Similarly, for a given angle ϕₙ for which neither rₙ nor Rₙ are defined, i.e., both rₙ and Rₙ are null, none of the region which the user desires to protect is within the signal path of sensor 12 along the angle ϕₙ.

Radar detection system 10 may be configured to allow a user to select location indicators which make up a vector of angles, such as angle vector [ϕ₁ . . . ϕ_{N}]. Protected region 200 is defined by the set of protected subregions 202, such that protected region 200 is made up of a set of linear segments which each extend along an angle ϕₙ from rₙ to Rₙ. The radius ranges rₙ and Rₙ of each angle ϕₙ can be varied as desired to achieve coverage of protected region 200. Additional radius ranges (such as, for example, [s₁ . . . s_{N}] and [S₁ . . . S_{N}]) can be selected to define more than one protected subregion 202 along an angle ϕₙ. While an outline of protected region 200 is illustrated in FIG. 3 for ease of viewing, it should be understood that only protected subregions 202 make up protected region 200.

During operation, radar detection system 10 can detect the presence of an object within any of protected subregions 202, such as object 204. If sensor 12 detects the presence of object 204 along any of angles ϕₙ between the defined radius ranges (i.e. between Rₙ and rₙ), controller 14 can, for example, trigger an alarm. Controller 14 can be further configured to not trigger an alarm if an object is detected outside of any protected subregions 202, such as object 206.

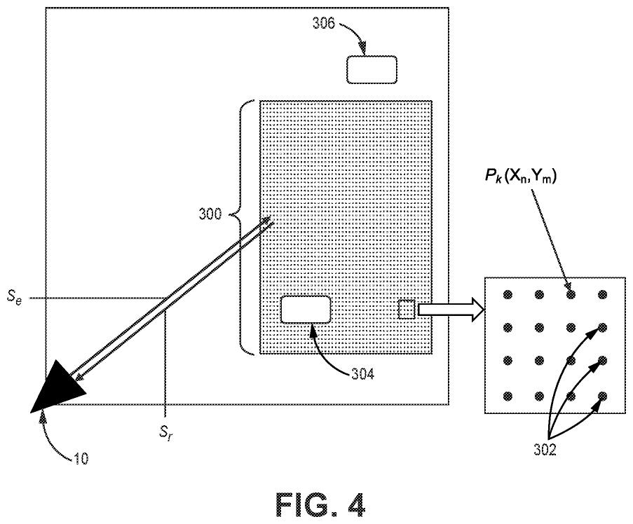

FIG. 4 is a perspective view of exemplary radar detection system 10 which is calibrated to use grid point vector [P₁ . . . P_{K}] and corresponding grid vector [(X₁, Y₁) . . . (X_{N}, Y_{M})] to define protected region 300. As discussed above, Pₖ denotes any of the points in grid point vector [P₁ . . . P_{K}] and (Xₙ, Yₘ) denotes any of the coordinates in grid vector [(X₁, Y₁) . . . (X_{N}, Y_{M})]. Each grid point Pₖ can have a corresponding location, given by coordinates (Xₙ, Yₘ). Each location as defined by coordinates (Xₙ, Yₘ) defines a protected subregion 302.

Radar detection system 10 may be configured to allow a user to select locations indicators which make up a vector of grid points which have x- and y-coordinates, such as grid point vector [P₁ . . . P_{K}]. Protected region 300 is defined by the set of protected subregions 302, such that protected region 300 is made up of a set of x- and y-coordinates.

During operation, radar detection system 10 can detect the presence of an object within any of protected subregions 302, such as object 304. If sensor 12 detects the presence of object 304 at coordinates (Xₙ, Yₘ) of any of grid points Pₖ, controller 14 can, for example, trigger an alarm. Controller 14 can be further configured to not trigger an alarm if an object is detected outside of any protected subregions 302, such as object 306.

As described above with respect to FIG. 1, the components of radar detection system 10 can calculate and interpret positional data about each emitted radar signal Sₑ and reflected radar signal Sᵣ. Positional data can be calculated from the time of flight of the radar signal as it travels from the transmitter, reflects off of the target, and travels to the receiver. Radar detection system 10 can determine the coordinate at which an emitted radar signal Sₑ was reflected based on the angle and time at which the emitted radar signal Sₑ is emitted and the time at which the reflected radar signal Sᵣ is received. For calibrations such as the one depicted in FIG. 4, this positional data can be decomposed into x- and y-coordinates using well-known mathematical techniques to determine at which point Pₖ emitted radar signal Sₑ was reflected.

While FIGS. 2-4 illustrate protected subregions which are in close proximity to each other, resulting in an approximately contiguous protected region, it should be understood that a designated protected region can have any suitable shape and can be made up of discrete protected subregions which do not overlap. This can, for example, result in a protected region which partially or entirely surrounds an area which is not designated as protected, as well as various other configurations.

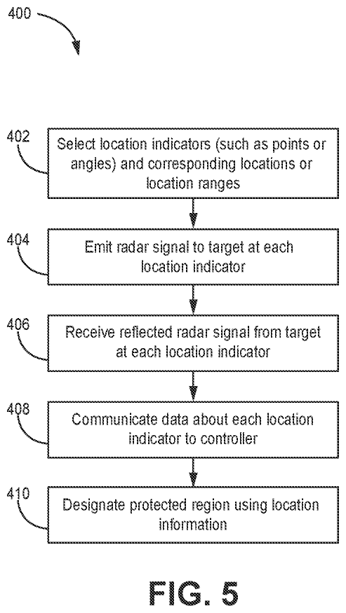

FIG. 5 illustrates exemplary method 400 of calibrating a radar detection system. Method 400 includes selecting location indicators and a corresponding location range for each location indicator (step 402), emitting a radar signal with a transmitter to the location range of each location indicator and reflecting the radar signal off of a target (step 404), receiving the reflected radar signal with a receiver (step 406), communicating the location of the target at each location indicator (step 408), and designating a protected region with the controller (step 410).

In step 402, a set of location indicators is selected. As described above with respect to FIGS. 2-4, this set of location indicators can be, for example, a vector of points or a vector of angles. An appropriate quantity of location indicators can be selected to provide coverage to the desired protected region. The selection of the set of location indicators can be achieved by a target moving through the area. The target may be a human, a robot, a drone, a vehicle, or some other moveable target. This selection can also be performed using a program stored in a memory unit of the radar detection system, and can be performed while the user is on location or remotely. A corresponding location range for each location indicator is also selected. As described above with respect to FIGS. 2-4, this set of location ranges can be, for example, a vector of radii, a vector of minimum and maximum radius ranges, or a grid of x- and y-coordinates. Each selected location range defines a protected subregion. The set of location ranges can be selected, for example, using a program stored in the memory unit. This selection can occur at any time during the calibration process after the location indicators are selected.

In step 404, a radar signal is emitted by a transmitter to each location indicator. In step 406, the radar signal is reflected off of a target and the reflected radar signal is detected by a receiver. Steps 404 and 406 will be discussed together. The target can be moved to each location indicator. The target can be, for example, a user performing calibration signals by moving and performing gestures that can be detected by the receiver. The calibration signals can be visible gestures or acoustic emissions. Visible gestures can be detected with the receiver using radar signals. The target can also be a user-directed device, such as a vehicle, drone, or other moveable target, which performs similar calibration signals. Visible gestures can include, for example, a stop in the target's movement for a selected period of time and/or a brief movement. A user can perform calibration signals in the form of visible gestures including a hand movement, a stop in movement such as a pause while walking, and/or a hand clap. A user can perform different visible gestures to designate different locations within the region. Acoustic emissions can include, for example, a noise emitted by the user, such as a hand clap or a voice command, and/or a noise emitted by a user-directed device. If acoustic emissions are used to signal that the target is at a desired location, the sensor 12 should include an acoustic detector (not shown) configured to detect the acoustic emissions. Any such acoustic emissions may be of any detectible wavelength suitable for the environment in which they are used. Any other calibration signals that are readily detectible by the receiver may also be used. During calibration, the receiver can detect the calibration location of each calibration signal which is performed, and the controller can record the calibration location associated with each location indicator and corresponding location range.

In step 408, positional data about the reflected radar signal for each location indicator is communicated between the sensor and a controller. Positional data can be calculated from the time of flight of the radar signal as it travels from the transmitter, reflects off of the target, and travels to the receiver.

In step 410, the controller designates a protected region based on input from the sensor and/or the user. Each location range of a location indicator defines a protected subregion. The protected region is defined by the sum of protected subregions. Once the controller has designated the protected region, the radar detection system has been calibrated and can detect the presence of objects within any of the protected subregions.

A radar detection system as described above provides numerous advantages. Calibrating a radar detection system using a set of selected location indicators, such as points or angles, and corresponding ranges allows the radar detection system to more accurately detect objects within the protected region. This increased accuracy results from the nature of the calibration process, which is more granular than conventional calibration methods. In addition, this calibration process more closely parallels the functioning of the radar detection system during use as compared to conventional methods, which also results in increased accuracy. Finally, the nature of the calibration process allows a user to easily calibrate the radar detection system by performing calibration signals or by selecting desired location indicators with a controller, and allows the user to easily tailor the protected subregions as desired to provide comprehensive and accurate security measures.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of calibrating a radar detection system, the method comprising:
selecting a plurality of location indicators, wherein each of the plurality of location indicators has a location;
emitting, with a transmitter of a sensor, a radar signal to the location of each of the plurality of location indicators;
reflecting the radar signal off of a target at the location of each of the plurality of location indicators;
receiving, with a receiver of the sensor, the radar signal which has been reflected off of the target at the location of each of the plurality of location indicators;
communicating, between the sensor and a controller, the location of the target at each of the plurality of location indicators;
selecting, with the controller, at least one plurality of locations received from the sensor, wherein the at least one plurality of locations selected with the controller defines a protected region; and
designating, with the controller, the protected region, thereby calibrating the radar detection system such that the radar detection system is capable of detecting an object in the protected region.

2. The method of claim 1, wherein each of the plurality of location indicators has at least one location range and each location range defines a protected subregion such that the protected region is defined by the plurality of protected subregions.

3. The method of claim 2, wherein the plurality of location indicators comprises a vector of points and the at least one location range of each of the vector of points is a plurality of radii about the point.

4. The method of claim 3, wherein selecting, with the controller, at least one plurality of locations comprises calculating, with the controller, a plurality of radii associated with each of the vector of points.

5. The method of claim 2, wherein the plurality of location indicators comprises a vector of angles and the at least one location range of each of the vector of angles is a radius range.

6. The method of claim 5, further comprising calculating, with the controller, a radius range associated with each of the vector of angles.

7. The method of claim 2, wherein each of the plurality of location indicators has an x-coordinate and a y-coordinate, and wherein the x-coordinate and the y-coordinate of each of the plurality of location indicators defines each of the protected subregions.

8. The method of claim 1, wherein selecting the plurality of location indicators comprises moving the target to each of the plurality of location indicators.

9. The method of claim 8, wherein selecting the plurality of location indicators comprises performing at least one calibration signal associated with each of the plurality of location indicators.

10. The method of claim 9, wherein the at least one calibration signal is selected from the group consisting of: a stop in movement, a movement, and an acoustic emission.

11. The method of claim 9, wherein:
the target performs the calibration signal; and
the target is selected from the group consisting of: a user and a user-directed device.

12. A method of detecting an object in a protected region with a calibrated radar detection system, the method comprising:
emitting, with a transmitter of a sensor, a radar signal to a location of each of a plurality of location indicators;
detecting, with a receiver of the sensor, if the radar signal has been reflected off of a target at the location of at least one of each of the plurality of location indicators;
communicating to a controller, with the sensor, if the radar signal has been reflected off of a target at the location of the at least one of each of the plurality of location indicators; and
determining, with the controller, that an object is present within the protected region based upon detection of the radar signal being reflected off of the target, wherein the protected region is defined by a plurality of protected subregions and each of the plurality of protected subregions is defined by a location of each of the plurality of location indicators.

13. The method of claim 12, further comprising triggering, with the controller, an alarm if the controller determines an object is present within the protected region.

14. The method of claim 12, wherein the location of each of the plurality of location indicators is defined by at least one plurality of radii.

15. A radar detector for a security system, the radar detector comprising:
a sensor, wherein the sensor comprises:
a transmitter, wherein the transmitter is configured to emit a radar signal to a plurality of location indicators;
a receiver, wherein the receiver is configured to receive a reflection of the radar signal from the transmitter that is reflected off of a target; and
a converter; and
a controller, wherein the controller is configured to communicate with the sensor to record a location of each of the plurality of location indicators, and wherein the controller is further configured to select at least one plurality of locations, designate a protected region which is defined by the at least one plurality of locations and thereby calibrate the radar detector, and determine if an object is present in the protected region.

16. The radar detector of claim 15, wherein the protected region is defined by a plurality of protected subregions and each of the plurality of protected subregions is defined by each of the locations of the location indicators.

17. The radar detector of claim 15, wherein the controller comprises a memory unit, at least one processor and at least one communication device.

18. The radar detector of claim 15, wherein the controller is further configured to trigger an alarm if an object is detected in the protected region.

19. The radar detector of claim 15, wherein the sensor is further configured to detect at least one calibration signal, and the controller is configured to communicate with the sensor to record a calibration location for each of the at least one calibration signals.

20. The radar detector of claim 15, wherein the controller is further configured to record at least one plurality of location ranges associated with the calibration location of each of the at least one calibration signals, and wherein each of the protected subregions is defined by each of the at least one plurality of location ranges.
